(19) United States
(12) Patent Application Publication
(10) Pub. No.: US 2003/0037154 A1
(43) Pub. Date: Feb. 20, 2003

(54) Protocol processor

(76) Inventors: Andrew A. Poggio, Palo Alto, CA (US); Leo A. Hejza, Sunnyvale, CA (US); Ariel Hendel, Cupertino, CA (US)

Correspondence Address: PARK, VAUGHAN & FLEMING LLP, 702 MARSHALL STREET, SUITE 310, REDWOOD CITY, CA, 94063, US

(21) Appl. No.: 09/931,476

(22) Filed: Aug. 16, 2001

(51) Int. Cl. G06F 15/16

(52) U.S. Cl. 709/230; 709/203

(57) ABSTRACT

A protocol processor is a specialized processor dedicated to extracting data (i.e., a payload) from an incoming communication (e.g., packet) and configuring outgoing data for transmission, and includes one or more protocol processing elements (PPE). Each PPE may be programmed to handle any set of communication protocols, and includes a set of large registers (e.g., 128 bytes, 256 bytes). A PPE also includes a parse unit for parsing packets to retrieve certain information and a lookup unit for accessing a control block indicating how to process an incoming packet or outgoing payload. A modification unit removes headers from incoming packets and/or adds them to outgoing data. A timer unit manages a large number of timers (e.g., for different communication streams). A control block cache may store recently accessed control blocks, and a data streaming unit streams packets (or packet portions) into and out of the registers.

### BACKGROUND

This invention relates to the field of computer systems. More particularly, an apparatus and methods are provided for processing communications through a series of communication protocols.

Electronic communications are typically processed, at their endpoints (e.g., source or destination), by general-purpose processors or computers executing software written for particular communication protocols. However, because general-purpose processors and systems are designed for many diverse tasks, they are inefficient at handling communications. For example, the registers used to process a communication are much smaller than the communication itself. As a result, processing the communication may require many shifts or other operations.

As the speed (e.g., bandwidth) of electronic communications continues to grow faster than the speed of general-purpose processors, the unsuitability of such processors for handling communications becomes ever more apparent. Computer systems relied upon for significant amounts of electronic communications (e.g., web servers, storage devices) are increasingly at risk of being overwhelmed.

Special purpose devices for handling electronic communications are presently limited to switches, routers and similar devices for moving communications from one path or link to another. Such devices are not configured to fully process or parse all types of protocols or redirect communication payloads based on their content.

### SUMMARY

In one embodiment of the invention a protocol processor, and a method of operating a protocol processor to execute or process the protocols of a communication, are provided. In this environment, a protocol processor is a specialized processor for retrieving a payload from an inbound electronic communication and/or packetizing an outbound set of data for transmission across a communication link.

In an embodiment of the invention, a protocol processor may include one or more protocol processing elements, and may also include an input queue element and an output queue element for managing the flow of communications and data. A communication interface couples the protocol processor to a communication link (e.g., a network) over which a communication may be received or transmitted. A data distribution interface couples the protocol processor to a local communication entity (e.g., a computer system, a storage device) that receives inbound data and/or originates data for transmission.

A protocol processing element may include various units or modules in an embodiment of the invention, including one or more large registers (e.g., 128 bytes, 256 bytes) for holding communications and data as they are processed. Other units of a protocol processing element may include a lookup unit for looking up information (e.g., accessing a control block that indicates how a communication or set of data may be processed), a parse unit for parsing a communication, a timer unit for managing timers and a modification unit for extracting payloads from inbound packets and/or attaching headers to outbound data. A protocol processing element may also include a control block cache and a data streaming unit for efficiently transferring communications and data.

### DESCRIPTION OF THE FIGURES

FIG. 1 is a block diagram depicting a protocol processor in accordance with an embodiment of the present invention.

FIG. 2 is a block diagram of a protocol processor element according to an embodiment of the present invention.

FIG. 3 is a flowchart illustrating one method of processing an incoming electronic communication with a protocol processor in accordance with an embodiment of the invention.

FIG. 4 is a flowchart illustrating one method of processing an outgoing electronic communication with a protocol processor in accordance with an embodiment of the invention.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

Techniques of the present invention may be implemented using a variety of technologies. For example, protocol processors described herein may be implemented utilizing either a combination of microprocessors or other specially designed application specific integrated circuits, programmable logic devices, or various combinations thereof. Further, the methods described herein may be facilitated by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

In one embodiment of the invention, a protocol processor is provided for processing the protocols associated with an electronic communication (e.g., a packet). Such processing may entail executing the associated protocols and/or manipulating the communication in accordance with the protocols. A method of processing a communication with a protocol processor is also provided.

In this embodiment, a protocol processor is significantly different from a general-purpose processor, which is configured to perform a variety of tasks without specializing or optimizing the performance of any one task. In contrast, the protocol processor is optimized for the processing of communications and communication protocols. In particular, and as described below, a protocol processor includes features not included in a general-purpose processor or other types of specialized processors.

In an embodiment of the invention, a protocol processor may be operated within or in cooperation with a general- or special-purpose computer system (e.g., client, server, peer) or other device that sends or receives electronic communications (e.g., hand-held computer, telephone, sensor, storage device, voice switch). Thus, a protocol processor may be installed as a separate hardware element of a computer system or other device. Alternatively, it may be installed on or with another element, such as a network interface circuit (NIC) or other communication interface. In these embodiments, the protocol processor operates at an endpoint or node of an electronic communication (i.e., either the origination or destination). However, in other embodiments, a protocol processor may be implemented at a location between the origination and destination of a communication.

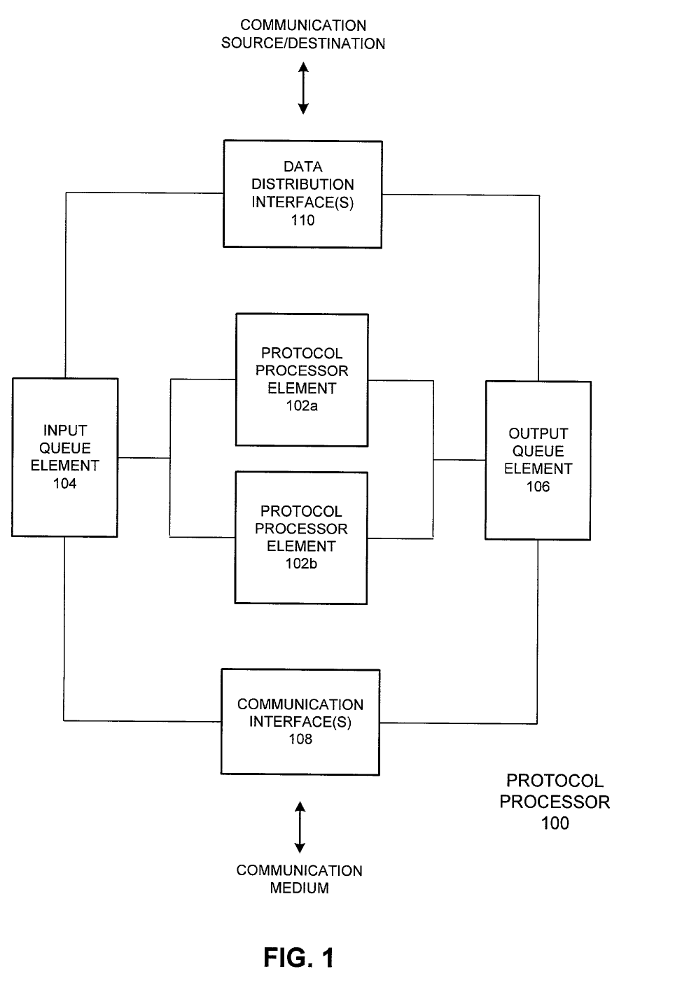

FIG. 1 depicts a protocol processor according to one embodiment of the invention. In the illustrated embodiment, protocol processor 100 includes multiple protocol processor elements (PPE) 102 (i.e., 102a, 102b). A protocol processor may include any number of PPEs (e.g., one or more) in different embodiments of the invention. Protocol processor 100 also includes input queue element 104, output queue element 106, network interface(s) 108 and data distribution interface(s) 110.

In the illustrated embodiment, protocol processor 100 is configured to exchange communications or communication elements (e.g., packets, frames, cells) between a network or other communication link and an entity such as a storage device, a computer processor, a computing device (e.g., a server, a client), a voice switch, a sensor, an application operating on a computing device, etc. For incoming communications, the protocol processor extracts the payloads (or removes all information—such as protocol headers—other than payloads) and forwards them to an appropriate entity. For outgoing communications, the protocol processor constructs or attaches the one or more protocol headers or trailers, or other protocol information.

Communication interface 108 provides a physical interface to a communication medium, which may be wired (e.g., optical, copper) or wireless, and is coupled to input queue element 104 and output queue element 106. Communication interface 108 may be modular in design, thereby providing flexibility in the type or topology of communication link with which a protocol processor is coupled. Data distribution interface 110 couples the protocol processor to the destination or origination of a communication.

The input and output queue elements provide queuing for, respectively, communications arriving at and leaving protocol processor 100. They may also provide quality of service (QoS) functions. For example, they may enforce priorities between different communications or communication streams and help ensure proper pacing of communications (e.g., for video or other media streams).

Protocol processor elements such as PPEs 102a, 102b are, in this embodiment of the invention, programmable elements capable of executing or processing one or more communication protocols. One PPE may be configured for the same or different set of protocols as another PPE within a single protocol processor. Illustratively, PPE 102a is configured to operate independently of PPE 102b, thereby allowing for significant performance gains from the use of multiple protocol processing elements.

In the illustrated embodiment, one chipset or chip (e.g., ASIC) may include protocol processor elements 102a, 102b, input queue element 104 and output queue element 106. However, input queue element 104 and output queue element 106 need not be located on the same chip or package as a protocol processor element. In different embodiments of the invention, each PPE may be a separate chip or multiple PPEs may be included on a single chip.

In one alternative embodiment of the invention, multiple sets of input and output queue elements may be included in a protocol processor. For example, one set of input and output queue elements may be coupled to a data distribution interface, while another set is coupled to a communication interface.

In the embodiment of FIG. 1, when a communication (e.g., packet, frame) is received at communication interface 108 from the communication medium, it is routed to input queue element 104. From there, it is accepted by a PPE, which processes the communication to extract its payload. The payload is sent through output queue element 106 to data distribution interface 110 for delivery to a destination entity. When data is received at data distribution interface 110 for transmission over the communication medium, it is routed to input queue element 104 to await an available PPE. A PPE packetizes the data (e.g., adds protocol headers) and sends it through output queue element 106 to communication interface 108.

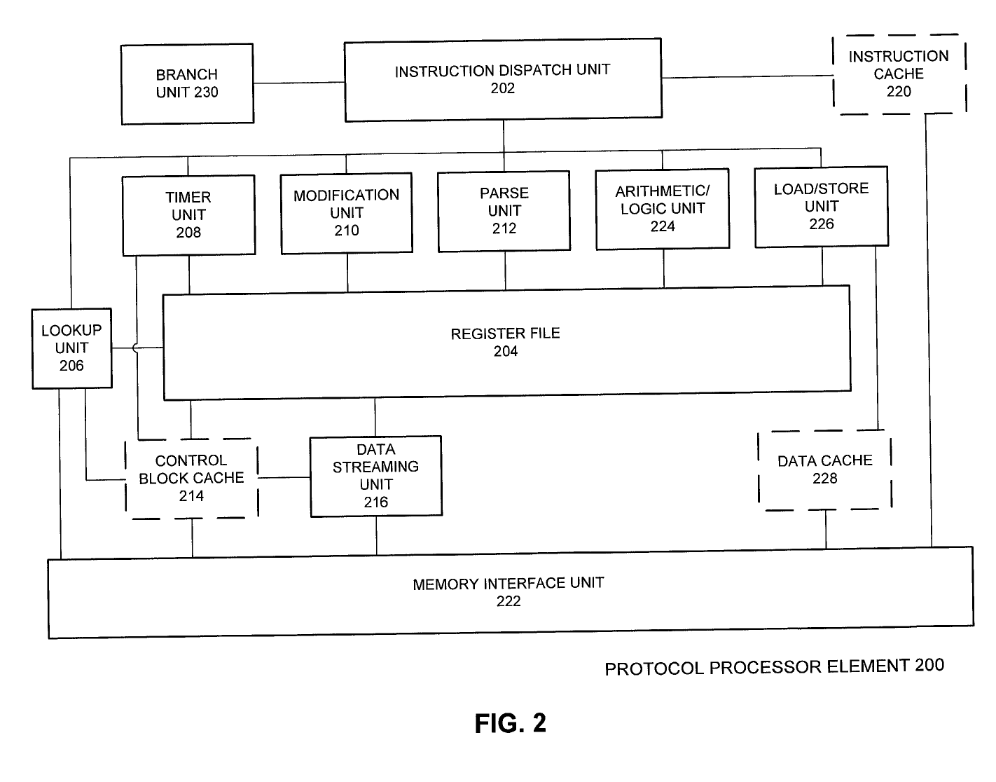

FIG. 2 is a block diagram of a protocol processing element (PPE) according to one embodiment of the invention. As discussed above, a protocol processor may include any number of PPEs, each of which may be programmed for any set of communication protocols.

In this embodiment, various components of a protocol processing element operate under the control or direction of a control unit, such as an instruction dispatch unit. Instruction dispatch unit 202 of PPE 200 may be coupled to an instruction cache 220, which may cache instructions from memory or storage accessed through memory interface unit 222.

In the illustrated embodiment, instruction dispatch unit 202 operates in conjunction with branch unit 230. Instruction dispatch unit 202 is also coupled to lookup unit 206, timer unit 208, modification unit 210, parse unit 212, arithmetic/logic unit 224 and load/store unit 226. Data cache 228 may store data from memory accessed through memory interface unit 222.

PPE 200 also includes register file 204, which includes one or more registers for storing the contents of a communication (e.g., a packet) or a portion of a communication (e.g., a payload) as it is manipulated or processed by the various components of the protocol processing element. In one embodiment of the invention, a PPE includes three registers, so that the contents of one register can be processed while another register is being populated (i.e., for processing) and the other is being emptied (i.e., after processing).

In the illustrated embodiment of the invention, the register(s) of register file 204 are relatively large in size, particularly in comparison to a typical register of a general-purpose processor. For example, whereas a register of a general-purpose processor may be on the order of 32 or 64 bits, a register in an embodiment of the invention may be measured in bytes (e.g., 64, 128, 256). In the illustrated embodiment of the invention, a register within register file 204 is large enough to store an entire packet header. In one alternative embodiment of the invention, a register is large enough to store an entire packet, frame or other communication unit (e.g., an ATM cell).

Register file 204 of FIG. 2 is coupled to lookup unit 206, timer unit 208, modification unit 210, parse unit 212, control block cache 214, data streaming unit 216, arithmetic/logic unit 224 and load/store unit 226.

Lookup unit 206 is configured to identify and/or retrieve control blocks. In this embodiment, control blocks indicate how to handle or process an incoming communication or an outgoing set of data. Control blocks may be retrieved from memory or storage accessed through memory interface unit 222, from data cache 228 or control block cache 214, or from a register in register file 204. Memory accessed through memory interface unit 222 by lookup unit 206 may be a Content Addressable Memory (CAM), a hash table, or other structure.

A lookup table or database that is searched by lookup unit 206 may contain hundreds of thousands of entries but, because lookup unit 206 is dedicated to the lookup task, it can accomplish this task in a timely manner. A control block lookup may be performed with a relatively large amount of information. In particular, a key used to do a control block lookup for an incoming communication may consist of any number of fields of a packet's protocol headers and information retrieved from a packet payload. For outgoing data, the sending entity may provide information for packetizing the data and/or for looking up a relevant control block. Extrinsic information may also be used in a lookup, such as the network port or connection through which a packet or set of data is received or is to be sent, the source or destination entity of a communication (e.g., a particular application or storage device), etc.

A control block lookup may be exact, meaning that only a control block matching the entire lookup key will be retrieved. Or, a lookup may retrieve any (e.g., the first) control block that matches a particular key pattern. Thus, a lookup key may include required fields—that a control block must match to be retrieved—and/or “don't care” fields—that need not, but may, be matched.

In the illustrated embodiment of the invention, lookup unit 206 may operate independently of, but in parallel with, other components of PPE 200 (e.g., timer unit 208, modification unit 210, parse unit 212, control block cache 214, data streaming unit 216).

Timer unit 208 manages timers for protocol processing element 200. The timer unit may manage a large number (e.g., thousands) of timers, depending on the number of communication streams handled by the PPE, their states, etc. In this embodiment of the invention, timers are used to retain or reflect the state of associated communication streams, or other events that have occurred or that may occur in the future. Individual timers may be inserted (e.g., for a new connection), deleted (e.g., for a closed connection), updated (e.g., to reflect connection activity), reset, etc. Upon expiration, a timer may be set to notify timer unit 208 and/or another unit or component of a protocol processing element.

In the embodiment of FIG. 2, timers may be associated with specific control blocks. For example, timer unit 208 is coupled to control block cache 214. When a timer managed by timer unit 208 expires, predetermined protocol processor code or instructions may be executed (e.g., to packetize and send data). In addition, timer unit 208 may operate independently of, and in parallel with, other components of PPE 200 (e.g., lookup unit 206, modification unit 210, parse unit 212, control block cache 214, data streaming unit 216).

Modification unit 210 modifies communications or communication elements. For example, when processing an outgoing set of data, modification unit 210 may construct one or more protocol headers, possibly based on information from a control block retrieved by lookup unit 206 and/or information provided by the originating entity (e.g., an application).

Conversely, when processing an incoming packet, modification unit 210 may delete or strip off protocol headers or fields within a header. In particular, modification unit 210 may remove all information other than the packet's payload. Thus, modification unit 210 may configure, reconfigure, add, delete or otherwise manipulate protocol fields, entire headers, and payloads.

Individual operations or manipulations performed by modification unit 210 may include insertion, deletion, shifting, addition, subtraction, replacement, etc. The large size of register file 204 may facilitate these operations.

Parse unit 212 parses packets or other communication elements (e.g., frames, cells) to retrieve or identify certain information. Parse unit 212 may parse packet payloads as well as protocol components (e.g., headers). A packet header may be examined, for example, to extract a destination address, TCP (Transport Control Protocol) sequence number, size of the packet's payload, etc. Protocol data and/or other information derived from a packet by parse unit 212 may be used to generate a lookup key used by lookup unit 206 to retrieve a corresponding control block.

The payload of the incoming packet may be parsed in an embodiment of the invention to enable content switching. In particular, based on the content of the payload, a protocol processor may determine or identify an appropriate entity to receive the packet. Thus, parse unit 212 may be configured to extract a URL (Uniform Resource Locator) from a payload, which may be part of an http (Hypertext Transport Protocol) or ftp (File Transfer Protocol) request or response. Based on information found in the payload, the protocol processor may then route a communication or packet to an appropriate server or application.

Parse unit 212 may operate according to a set of unique instructions (e.g., unique for each protocol or protocol stack it is programmed for). The instructions may require it to find a specified field of a header, extract the value stored in a particular field, compare the contents of a header field to a predetermined string, etc.

Control block cache 214 caches recently accessed control blocks to facilitate their rapid retrieval. Because of the bursty nature of much network traffic, multiple packets in one communication stream may be received in a short period of time, and one control block may indicate how to process all packets in the stream. In the illustrated embodiment of the invention, control block cache 214 is coupled to lookup unit 206, timer unit 208 and data streaming unit 216, as well as register file 204 and memory interface unit 222.

Data streaming unit 216 in PPE 200 is dedicated to streaming packets or other communication elements into and out of the register(s) of register file 204 and/or control block cache 214, without having to rely on a slower component, such as load/store unit 226. In the embodiment of FIG. 2, data streaming unit 216 is configured to stream data (e.g., packet contents, control block) into one register and/or out of another register, even while other components of PPE 200 are processing the contents of another register.

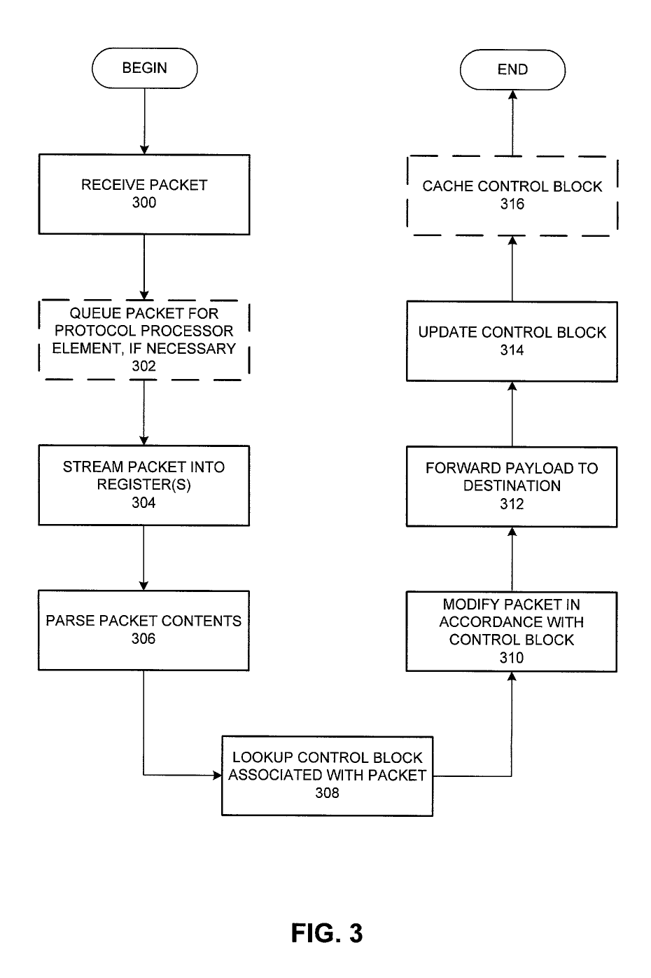

FIG. 3 depicts one method by which a protocol processor may process a communication element (e.g., a packet) received from a communication link, according to one embodiment of the invention. In this embodiment, the protocol processor receives the packet from the link, processes it according to a corresponding control block and forwards the payload (and protocol information, if necessary) to an appropriate destination entity.

In state 300, a packet is received at a communication interface of the protocol processor. For example, in a computer system, a protocol processor may be situated on the same card or board as a network interface circuit. In this case, the communication interface module receives the packet from the network interface circuit. In one embodiment of the invention, a network interface circuit may comprise a communication interface module, or vice versa.

In state 302, the packet is queued for a protocol processor element (PPE). The packet may be stored in an input queue element, as shown in FIG. 1. Otherwise, the packet may be buffered or stored until the PPE can accept it.

In state 304, a data streaming unit of a PPE within the protocol processor streams the packet, or some portion of the packet, into a register. If the entire packet will not fit in the register, in one embodiment of the invention the packet header is placed in the register and processed first, followed by the payload, if necessary. The entire packet may thus be processed piece by piece in the one register or, alternatively, the packet may be divided among multiple registers for faster processing.

In state 306 a parse unit parses as much of the packet as is necessary to retrieve necessary information. This may include some or all protocol headers as well as the payload. In this embodiment of the invention, the parse unit operates according to a set of instructions configured to fully parse a protocol header. Data that may be retrieved from protocol headers includes a source/destination address or other identifier, payload size, protocol-specific information such as a TCP port number or IP version, etc. As already described, parsing the payload helps identify a corresponding control block, and may allow the protocol processor to make an intelligent determination as to where to send the payload (e.g., based on a URL or other content within the payload). Another reason for parsing a payload is that some protocol information may be stored there.

In state 308 a lookup unit identifies a control block associated with the packet or a communication stream comprising the packet. Any or all of the information derived by the parse unit may be used in the lookup, as well as other information beyond the packet itself—such as the port through which the packet was received.

Illustratively, the control block contains information that the PPE needs in order to process the packet, and may be hundreds of bytes in size. It may include protocol-specific information for ensuring that the packet is acceptable. For example, a control block may identify a TCP sequence window comprising a range of acceptable TCP sequence numbers. If the packet's TCP sequence number is outside this window, it may be rejected. As packets in the stream associated with the control block are received and processed, the window is adjusted or moved to keep pace with the stream.

The control block may also indicate whether an acknowledgement should be sent to the originator of the packet. The protocol processor may return an acknowledgement if the packet is received intact and a desire for such a response is indicated. The control block may also indicate whether an acknowledgement, if required, can be piggybacked with a packet heading back to the originator. Further, the control block may identify a possible recipient or destination of the packet—such as a server, a storage device, a voice switch, another protocol processor, or virtually any other possible data sink—and, possibly, how to get it to that recipient. Yet further, a control block may indicate a QoS, such as whether and how a data stream from the communication link should be paced or throttled. For example, if a multimedia stream is configured for a certain data rate, the protocol processor and/or an output queue element may attempt to enforce that rate.

A control block will also normally identify a set of timers associated with the corresponding communication stream. Different timers, which may be managed or monitored by a timer unit, may be associated with different statuses or events. For example, a timer for an outgoing communication stream may be used to determine whether a communication (e.g., a packet) that was sent is acknowledged within a certain period of time. If not, the timer expires and the communication may be sent again. A timer for an incoming stream may be used to determine if the stream has been quiescent for a threshold period of time. If so, its connection may be torn down.

In state 310, the packet is modified in accordance with the applicable control block. In particular, the PPE may strip off everything but the payload, to prepare it for transmission to its destination.

In state 312, the modified packet (e.g., its payload) is forwarded to its destination. As indicated above, the destination may be any type of computing device or component, an application operating on such a device, another protocol processor element, etc. To forward the packet payload, it may be stored in an output queue element (as shown in FIG. 1) before being sent through a data distribution interface toward the destination.

In state 314 the control block is updated, perhaps to change a TCP sequence window, a destination (e.g., a destination memory address may be updated to the memory area in which the next packet payload should be stored), etc. Information other than a control block may also be changed to reflect the processing of the packet. For example, a timer may be reset or a timer value altered. However, if the just-processed packet was the final packet in its stream, then the control block may be deleted rather than updated. In this case, the lookup table or database containing the control block would be updated accordingly.

In state 316, the control block may be cached (if the stream has not ended), thereby allowing it to be retrieved quickly if another packet in the same stream is received in the near future.

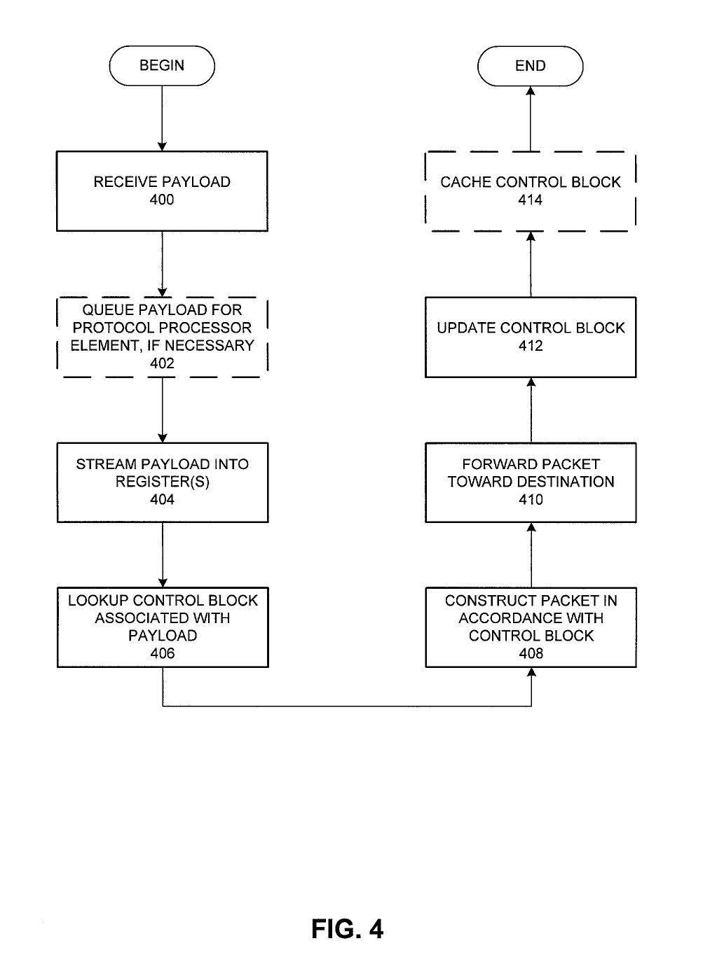

FIG. 4 demonstrates a method of processing an outgoing communication or set of data through a protocol processor, according to one embodiment of the invention.

In state 400 of this method, a set of data (e.g., a payload) is received or obtained from a data source. The payload may be received through a data distribution interface from a direct communication link, a wireless link, etc. In this embodiment of the invention, the protocol processor may receive the payload from the source along with relevant information (e.g., where to send it, how to select an appropriate control block). Or, the protocol processor may determine—possibly through the expiration of a timer associated with an outgoing stream—that another payload in the stream should be sent. For example, the source may be streaming a media file to a destination, which may require regular transmissions of data. The timer may be associated with a control block that corresponds to the communication stream. If the payload is being sent according to a schedule, the corresponding control block (e.g., identified by the timer) may indicate where and/or how to retrieve the data from its source.

In state 402, the payload may be queued to await an available protocol processor element, if the protocol processor includes multiple PPEs and all are busy. Also, not all PPEs of a protocol processor may be programmed for the same communication protocols. Thus, a payload may have to be queued to await a suitably configured PPE.

In state 404 the payload (or a portion thereof) is streamed into one or more registers of a protocol processing element. Thus, the payload may be processed in stages, across multiple registers, or, if one register is large enough, it may be processed all at once.

In state 406 a lookup unit identifies and/or retrieves a control block associated with the outgoing payload. The appropriate control block may be easily identified if the payload is being sent in accordance with a timer associated with the control block. Otherwise, details provided by the data source (e.g., destination address or identity, a queue pair for Infiniband) and/or other information (e.g., the outgoing communication link or network) may be used to identify the correct control block.

In state 408, the payload is modified (e.g., by a modification unit). In particular, the payload may be packetized by adding one or more headers, trailers and/or other protocol information that will facilitate transmission of the payload to its destination. The PPE may use information drawn from the control block, and/or other sources, in packetizing the payload. The large size of the registers in this embodiment of the invention makes it relatively easy to shift the payload as necessary to insert or attach headers.

In state 410 the newly generated packet is moved to an outgoing communication interface (e.g., a network interface) and forwarded toward its destination. The packet may be queued in an output queue element before being transmitted.

In state 412 the control block for the packet's communication stream is updated. In particular, the state of the stream is updated to reflect the packet that was sent. Depending on whether the stream has just commenced (e.g., this was the first packet) or finished (e.g., this was the last packet), other action may be taken as necessary and appropriate. For example, if the stream is finished, then the control block will be deleted, and the lookup table updated.

In state 414, the control block may be cached (e.g., in a control block cache) if the stream is to continue.

The foregoing descriptions of embodiments of the invention have been presented for purposes of illustration and description only. They are not intended to be exhaustive or to limit the invention to the forms disclosed. Accordingly, the above disclosure is not intended to limit the invention; the scope of the invention is defined by the appended claims.

What is claimed is:

1. A protocol processor for processing electronic communications, comprising:
a communication interface configured to receive an inbound communication from a communication link and send an outbound communication to the communication link;
a data distribution interface configured to receive outbound data from a communication entity and send inbound data to the communication entity; and
a first protocol processing element configured to extract said inbound data from said inbound communication and generate said outbound communication from said outbound data, wherein said protocol processing element comprises:
a register file for storing one of:
said inbound communication as said inbound data is extracted; and
said outbound data as said outbound communication is generated;
a parse unit for retrieving data from said inbound communication;
a lookup unit for using said retrieved data to identify a first control block indicating how to extract said inbound data; and
a modification unit for performing one or more of said extraction and said generation.

2. The protocol processor of claim 1, wherein said register file comprises one or more registers.

3. The protocol processor of claim 2, wherein a first register in said register file is large enough to store said inbound communication intact.

4. The protocol processor of claim 2, wherein a first register in said register file is large enough to store said outbound data intact.

5. The protocol processor of claim 2, wherein a first register in said register file stores a portion of said inbound communication for said extraction and a second register in said register file stores said outbound data for said generation.

6. The protocol processor of claim 1, wherein said inbound communication is a packet.

7. The protocol processor of claim 1, further comprising a second protocol processing element.

8. The protocol processor of claim 1, wherein said first protocol processing element further comprises a timer unit for managing a timer associated with a communication stream involving said communication entity.

9. The protocol processor of claim 1, further comprising a control block cache for caching said first control block.

10. The protocol processor of claim 1, further comprising a data streaming unit configured to stream said inbound communication into said register file.

11. The protocol processor of claim 10, wherein said data streaming unit is further configured to stream said outbound communication out of said register file.

12. A protocol processor for processing a packet received from a communication link, comprising:
a first register configured to store a header of a first packet received from a communication link;
a parse unit coupled to said first register and configured to parse said header to extract data from one or more header fields;
a lookup unit coupled to said first register and configured to use said data to identify a control block associated with the first packet, wherein said control block indicates how the first packet may be processed; and
a modification unit coupled to said first register and configured to modify the first packet.

13. The protocol processor of claim 12, further comprising a timer unit coupled to said first register and configured to manage a set of timers associated with a communication stream comprising the first packet.

14. The protocol processor of claim 12, further comprising a control block cache coupled to said first register and configured to store said control block for use when a subsequent packet in the same communication stream as the first packet is received.

15. The protocol processor of claim 12, further comprising a data streaming unit coupled to said first register and configured to load said header into said first register.

16. The protocol processor of claim 15, wherein said data streaming unit is also configured to load said control block into a control block cache.

17. The protocol processor of claim 12, wherein said parse unit is further configured to parse a payload of the first packet.

18. The protocol processor of claim 17, wherein said payload is parsed to extract information for identifying a destination entity to which said payload may be forwarded.

19. The protocol processor of claim 12, wherein said modifying said header comprises removing said header.

20. The protocol processor of claim 12, wherein said first register is greater than 64 bytes in size.

21. The protocol processor of claim 12, wherein said first register is large enough to store said first packet.

22. A protocol processor configured to prepare a set of data for transmission over a communication link, comprising:
a first register configured to store a set of data as one or more protocol headers are constructed for said set of data to facilitate transmission of said set of data over a communication link;
a lookup unit coupled to said first register and configured to identify a control block configured to indicate how to construct said protocol headers;
a modification unit coupled to said first register and configured to assemble said protocol headers in said first register according to said control block; and
a timer unit coupled to said first register and configured to manage a set of timers associated with said control block to ensure that said set of data is transmitted within a predetermined period of time.

23. The protocol processor of claim 22, further comprising a control block cache coupled to said first register and configured to store said control block for use with a second set of data.

24. The protocol processor of claim 22, further comprising a data streaming unit coupled to said first register and configured to stream said protocol headers and said set of data from said first register toward the communication link.

25. The protocol processor of claim 22, further comprising a data streaming unit coupled to said first register and configured to load said header into said first register.

26. The protocol processor of claim 25, wherein said data streaming unit is further configured to load said control block into a control block cache.

27. The protocol processor of claim 22, wherein said first register is greater than 64 bytes in size.

28. The protocol processor of claim 22, wherein said first register is large enough to store said first packet.

29. A method of extracting a payload from an electronic communication, comprising:
receiving an electronic communication comprising a payload and one or more protocol headers;
storing a first portion of the communication in a register, wherein said first portion comprises said protocol headers;
extracting communication details from said first portion of the communication;
retrieving a control block indicating how to process the communication, wherein said control block is identified with said communication details;
forwarding said payload to a destination of the communication; and
updating said control block.

30. The method of claim 29, wherein said storing a first portion comprises storing the electronic communication, in its entirety, in said register.

31. A method of packetizing a set of data for transmission, comprising:
receiving a set of data from a source communication entity for transmission over a communication link;
storing the set of data in a register;
identifying a control block indicating how to process the set of data, wherein said control block is identified using information provided by the source communication entity;
adding one or more protocol headers to the set of data to form a communication packet;
streaming said communication packet from said register for transmission over the communication link; and
updating said control block.

32. The method of claim 31, wherein said storing the set of data comprises storing the entire set of data in a single register.

33. The method of claim 31, wherein said register is large enough to store all of said protocol headers.
